(19) United States
(12) Patent Application Publication
(10) Pub. No.: US 2023/0067271 A1
(43) Pub. Date: Mar. 2, 2023

(54) INFORMATION PROCESSING METHOD AND ELECTRONIC DEVICE

(71) Applicant: Lenovo (Beijing) Limited, Beijing (CN)

(72) Inventor: Hongcheng XIA, Beijing (CN)

(21) Appl. No.: 17/686,251

(22) Filed: Mar. 3, 2022

(30) Foreign Application Priority Data
Aug. 30, 2021 (CN) 202111006141.0

(51) Int. Cl. H04R 3/00; H04R 29/00; H04R 1/40; G06F 3/16; G06T 11/00

(52) U.S. Cl. CPC H04R 3/005; H04R 29/008; H04R 1/406; G06F 3/165; G06T 11/00; H04R 2430/01; H04R 2410/01

(57) ABSTRACT

An information processing method includes, in response to determining that an application is in a video mode, acquiring a video image in real time through a camera group of an electronic device and acquiring a video sound in real time through a microphone group of the electronic device; displaying the video image; mapping an audio manipulation area that includes an operation response area of a sound source in an acquisition area of the camera group; obtaining an input operation for the operation response area; and, in response to the input operation, adjusting a sound collection effect of the sound source corresponding to the operation response area.

### CROSS-REFERENCE TO RELATED APPLICATION

This application claims priority to Chinese Patent Application No. 202111006141.0, filed on Aug. 30, 2021, the content of which is incorporated herein by reference in its entirety.

### TECHNICAL FIELD

The present disclosure generally relates to the field of control and, more particularly, to an information processing method and an electronic device.

### BACKGROUND

When recording a video, such as recording a birthday wishes video or a family gathering video, all sound of the scene is usually recorded during a recording process, which will lead to more noise in recorded video files and reduce user experience.

### SUMMARY

In accordance with the disclosure, there is provided an information processing method including, in response to determining that an application is in a video mode, acquiring a video image in real time through a camera group of an electronic device and acquiring a video sound in real time through a microphone group of the electronic device; displaying the video image; mapping an audio manipulation area that includes an operation response area of a sound source in an acquisition area of the camera group; obtaining an input operation for the operation response area; and, in response to the input operation, adjusting a sound collection effect of the sound source corresponding to the operation response area.

Also in accordance with the disclosure, there is provided an electronic device including a camera group, a microphone group, a display screen, and a processor. The processor is configured to, in response to determining that an application is in a video mode, control the camera group to acquire a video image in real time and control the microphone group to acquire a video sound in real time; control the display screen to display the video image; map an audio manipulation area that includes an operation response area of a sound source in an acquisition area of the camera group; obtain an input operation for the operation response area; and, in response to the input operation, adjust a sound collection effect of the sound source corresponding to the operation response area.

### BRIEF DESCRIPTION OF THE DRAWINGS

To more clearly illustrate the embodiments of the present disclosure, the accompanying drawings that are used in the description of the embodiments are briefly described here. The following drawings are merely examples for illustrative purposes according to various disclosed embodiments and are not intended to limit the scope of the present disclosure. For those skilled in the art, other drawings may also be obtained from these drawings without any creative effort.

FIG. 1 is a flow chart of an example information processing method consistent with the present disclosure.

FIG. 2 is a flow chart of another example information processing method consistent with the present disclosure.

FIG. 3 is a flow chart of another example information processing method consistent with the present disclosure.

FIG. 4 is a schematic structure diagram of an example electronic device consistent with the present disclosure.

### DETAILED DESCRIPTION OF THE EMBODIMENTS

Hereinafter, embodiments and features consistent with the disclosure will be described with reference to drawings. The embodiments described below are merely a part of embodiments of the present disclosure, and do not limit the scope of the present disclosure. Various modifications may be made to the embodiments of the present disclosure. Thus, the described embodiments should not be regarded as limiting, but are merely examples. Those skilled in the art will envision other modifications within the scope and spirit of the present disclosure.

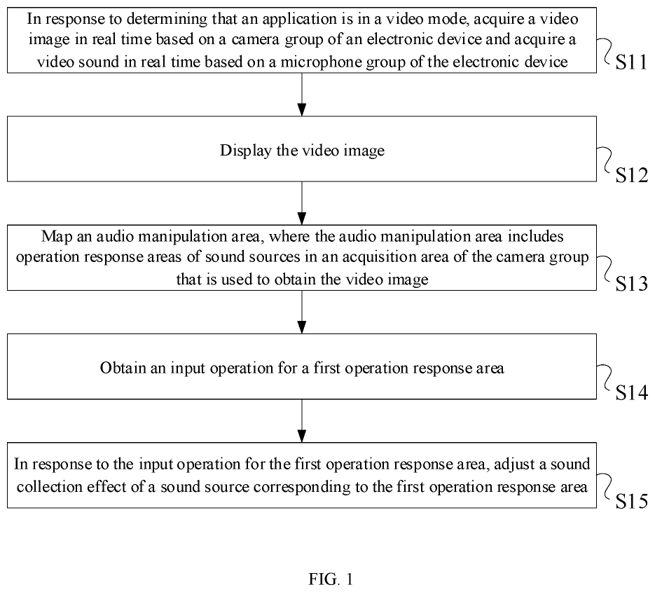

The present disclosure provides an information processing method. As shown in FIG. 1, in one embodiment, the information processing method includes S11 to S15.

At S11, in response to determining that an application is in a video mode, a video image is acquired in real time based on a camera group of an electronic device and a video sound is acquired in real time based on a microphone group of the electronic device.

At S12, the video image is displayed.

At S13, an audio manipulation area is mapped. The audio manipulation area includes operation response areas of sound sources in an acquisition area of the camera group that is used to obtain the video image.

At S14, an input operation for a first operation response area of the operation response areas is obtained.

At S15, in response to the input operation for the first operation response area, a sound collection effect of a sound source corresponding to the first operation response area is adjusted.

When the electronic device is in the video mode, for example, when a mobile phone is recording a video or a tablet computer is making a video call, the video image may be obtained through the camera group of the electronic device, and the video sound may be obtained through the microphone group of the electronic device.

In this process, the obtained video image may be the image corresponding to the acquisition area of a camera that is turned on in the camera group, and the obtained video sound may be all sound that can be obtained by the microphone group in the environment where the electronic device is located. There may be a problem of cluttered sound and more noise caused by the complex environment.

To avoid this problem, in the present disclosure, when the video image obtained by the camera group is displayed on a display screen of the electronic device, the audio manipulation area may be mapped on the display screen, and the audio manipulation area may include the operation response areas of the sound sources in the acquisition area of the camera group that is used to obtain the video image.

The audio manipulation area may be an area where the sound of the sound sources in the acquisition area corresponding to the acquired video image is manipulated, such that the sound of the sound sources in the acquisition area corresponding to the acquired image is able to be manipulated to enhance or suppress sound collection effects of some of the sound sources in the acquisition area corresponding to the acquired image.

In one embodiment, the electronic device may include a plurality of camera groups. When the electronic device is in the video mode, more than one camera group of the plurality of camera groups may be in the open state. For example, there may be 3 cameras in one camera group, and when an application of the electronic device is in the video mode, there may be one or two camera groups in the open state. Therefore, it may need to first determine the acquisition area of a camera group in the open state, that is, the acquisition area of a camera group used to acquire the video image. Only the sound source in the acquisition area may be manipulated, and only the sound collection effect of the sound source in the acquisition area may be manipulated through the audio manipulation area.

The audio manipulation area may be a gesture input area without operation controls. Correspondingly, this area may not need to be displayed on the display screen, and the area is able to respond to gesture operations. The gesture operations may include sliding operations.

In another embodiment, the audio manipulation area may be a gesture operation control. At this time, the audio manipulation area may be displayed on the display screen, and the manipulation of the sound source in the acquisition area may be realized by selecting or sliding the gesture operation control.

The audio manipulation area may include at least one operation response area, and each operation response area may correspond to one sound source, or several sound sources may correspond to one operation response area.

Specifically, each sound obtained by the microphone group may have a corresponding direction, and one operation response area displayed in the audio manipulation area may correspond to a direction of one corresponding sound source. Sound sources in a same direction relative to the electronic device may use a same operation response area, and the operation response area may also correspond to this direction.

That is, in one embodiment, the audio manipulation area may include at least two operation response areas, and positions of the at least two operation response areas on the audio manipulation area may be related to the directions of the sound sources corresponding to the at least two operation response areas.

For example, there may be two sounds in the acquisition area of the camera group that is used to obtain the video, and the sound sources of the two sounds may be located at an upper left corner and an upper right corner of the electronic device respectively. The first sound source may be located at the upper left corner of the electronic device, and the second sound source may be located at the upper left corner of the electronic device. An operation response area corresponding to the first sound source may be located at a left side of the audio manipulation area, and an operation response area corresponding to the second sound source may be located at a right side of the audio manipulation area. Therefore, when the left operation response area is operated, the sound collection effect of the first sound source located at the upper left corner of the electronic device may be controlled; and when the right operation response area is operated, the sound collection effect of the second sound source located at the upper right corner of the electronic device may be controlled.

When two sounds are output from the same direction of the acquisition area at the same time, whether a difference between the angles of the positions of the sound sources of the two sounds with respect to the electronic device is greater than a preset value may be determined. When the difference is greater than the preset value, the two sounds may be determined to be from two different sound sources respectively, and different operation response areas may be set for the two sound sources. When the difference of the angles is less than or equal to the preset value, the above two sounds may be determined to be from one sound source, and a same operation response area may be set for the two sound sources. Similarly, when there are multiple sounds, when the difference between the angles of the positions of the sound sources with respect to the electronic device is greater than the preset value, different operation response areas may be set respectively for the sound sources. When the difference between the angles is not greater than the preset value, a same operation response area may be set.

The input operation for the first operation response area in the audio manipulation area may be obtained, and the sound collection effect for the sound source corresponding to the first operation response area may be adjusted in response to the input operation for the first operation response area.

The input operation may be performed on one operation response area of the operation response areas in the audio manipulation area. Then after responding to the input operation, the obtained sound of the sound source corresponding to the operation response area may be actually adjusted, for example, a volume of the sound of the sound source corresponding to the operation response area may be increased or decreased.

In another embodiment, parameters of the microphone may be adjusted directly, such that what is obtained in the process of obtaining sound through the microphones is the sound that meets the user's needs after the microphone is adjusted. For example, the input operation may be performed on the operation response area in the audio manipulation area and the operation response area may correspond to the sound source at the upper left corner. Therefore, when the sound is obtained through the microphone group, the sound obtained may be a sound where the sound source at the upper left corner is suppressed, that is, the microphone group may be directly controlled to not collect the sound of the sound source at the upper left corner.

Further, when the application of the electronic device is in the video mode, if the audio manipulation area needs to be operated, there may be usually at least two sound sources in the acquisition area of the camera group that obtains the video image. It may be meaningful to adjust the sound collection effect of one or more of the at least two sound sources only when there are at least two sound sources in the acquisition area corresponding to the image.

In one embodiment, in the video mode, the sound collection effect of the sound source may be adjusted before the video recording starts. When the electronic device is in the video mode, the camera group may be able to obtain the video image and the microphone group may be able to obtain the video sound, in a preview mode before the recording starts. In this situation, adjusting the sound collection effect of the sound source in the acquisition area corresponding to the video image may make all the sounds in the final recorded video are sounds based on the adjusted sound collect effect, which is more in line with the user needs.

In another embodiment, during the video recording process in the video mode, the camera group may obtain the video image, and the microphone group may obtain the video sound. When the user determines that sound of a sound source in a certain direction reduces the sound effect in the video, the input operation on a corresponding operation response area through the mapped sound manipulation area may be used to adjust the sound collection effect of the sound source corresponding to the operation response area, to realize the adjustment of the sound in the video based on the user's adjustment of the sound collect effect of the sound source during the video recording process.

During the video recording process, the video image may be displayed on the display screen, and the audio manipulation area may be always mapped on the display screen, to ensure that the user is able to adjust the sound collection effect of the sound source at any time during the video recording process.

During the video recording process, when the video image is displayed on the display screen and the audio manipulation area is always mapped on the display screen, no matter whether the audio manipulation area is a gesture input area that does not need to be displayed or a gesture operation control that needs to be displayed on the display screen, it may not affect the display of the video images on the display screen. When the audio manipulation area is a gesture input area that does not need to be displayed, it may not affect the display of the video image on the display screen. When the audio manipulation area is a gesture operation control that needs to be displayed on the display screen, it may be superimposed and displayed on the video image with a high transparency, such that the gesture control element does not affect the video images.

In the information processing method provided by the present embodiment, when the application is in the video mode, the video image may be obtained in real time based on the camera group of the electronic device and the video sound may be obtained in real time based on the microphone group of the electronic device. The video image may be displayed, and the audio manipulation area may be mapped. The audio manipulation area may include the operation response areas of the sound sources in the acquisition area of the camera group that obtains the video image. The input operation for the first operation response area may be obtained. In response to the input operation for the first operation response area, the sound collection effect of the sound source corresponding to the operation response area for the first operation response area may be changed. In the present embodiment, when the application is in the video mode, the mapped audio manipulation area may be used to control the sound source corresponding to the first operation response area in the corresponding acquisition area of the captured video image, thereby realizing the control of the sound collection effect of the sound source corresponding to the operation response area. Therefore, the sound source in the video images may be based on the user's control of a certain operation response area in the image acquisition area, and the selection of the sound source in the video images may be achieved, to effectively avoid the problem of degraded user experience caused by more noise in the video images.

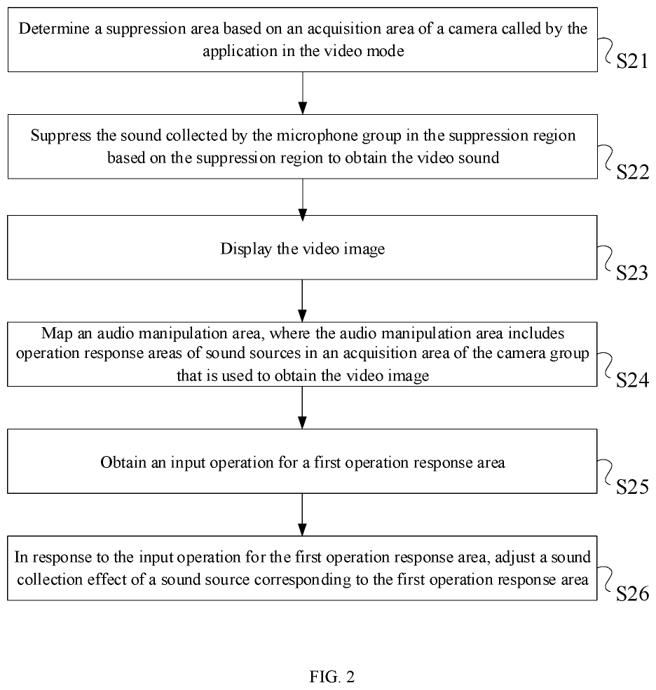

Another embodiment shown in FIG. 2 provides another information processing method. As shown in FIG. 2, the method includes S21 to S26.

At S21, a suppression area is determined based on an acquisition area of a camera called by the application in the video mode.

At S22, the sound collected by the microphone group in the suppression region is suppressed based on the suppression region to obtain the video sound.

At S23, the video image is displayed.

At S24, the audio manipulation area is mapped. The audio manipulation area includes the operation response areas of the sound sources in the acquisition area of the camera group that obtains the video image.

At S25, the input operation for the first operation response area is obtained.

At S26, in response to the input operation for the first operation response area, the sound collection effect for the sound source corresponding to the first operation response area is adjusted.

When the application of the electronic device is in the video mode, the video image may be obtained through the camera group of the electronic device, and the video sound may be obtained through the microphone group of the electronic device. In this process, the acquisition area of the images obtained by the camera group may be determined, and based on the acquisition area, the sound obtained by the microphone group may be determined.

Specifically, the video sound obtained by the microphone group may be determined based on the acquisition area. The suppression area may be determined based on the acquisition area, and the sound in the suppression area collected by the microphone group may be suppressed based on the suppression area to obtain the video sound.

The electronic device may include a plurality of microphones, for example, at least three microphones. The plurality of microphones may be used to acquire the sound in the environment respectively, to collect the sound through one or more microphones of the plurality of microphones at the same time. The electronic device may also include a plurality of cameras at the same time, for example, at least one camera. Different cameras of the plurality of cameras, for example, a front camera and a rear camera of a mobile phone, may correspond to different acquisition areas, and the video image may be collected through one or more cameras of the plurality of cameras at the same time.

When the electronic device turns on different cameras of the plurality of cameras, there may be different acquisition areas. Therefore, when the electronic device is in the video mode, it may be needed to first determine the acquisition area corresponding to the video image obtained by the cameras that are turned on. The sound corresponding to the video that the user needs to obtain should also be the sound corresponding to the acquisition area. Therefore, in the present embodiment, to obtain the video sound, only the sound in the acquisition area corresponding to the video image may need to be obtained, that is, the sound of sound sources in other areas other than the acquisition area may be suppressed to ensure that what is obtained in real time through the microphone group is the sound in the acquisition area and the sound corresponding to the video image.

Specifically, the area outside the acquisition area in the environment may be determined as the suppression area. When the sound is collected through the microphone group, only the sound of the sound sources in the acquisition area may be directly obtained, and the sound of the sound sources in the suppression area may be suppressed. Therefore, it may be ensured that the sound sources of the sound obtained through the microphone group are all located in the acquisition area.

Since the position of the sound source corresponding to the operation response area in the audio manipulation area is in the acquisition area, the sound source in the acquisition area may be further selected through the audio manipulation area to ensure that the final sound collection effect corresponds to a part of the area in the acquisition area that is determined based on the input operation.

For example, the video image may be collected by the front camera of the mobile phone. Therefore, the acquisition area may correspond to the acquisition area of the front camera of the mobile phone, and the suppression area may be the area other than the acquisition area of the front camera. The sound obtained by the microphone group in real time may be the sound of the sound sources in the acquisition area of the front camera, and the operation response area may be further selected through the input operation, to adjust the sound collection effect of the sound source in a part of the acquisition area.

In the information processing method provided by the present embodiment, when the application is in the video mode, the video image may be obtained in real time based on the camera group of the electronic device and the video sound may be obtained in real time based on the microphone group of the electronic device. The video image may be displayed, and the audio manipulation area may be mapped. The audio manipulation area may include the operation response area of the sound source in the acquisition area of the camera group that obtains the video image. The input operation for the first operation response area may be obtained. In response to the input operation for the first operation response area, the sound collection effect of the sound source corresponding to the first operation response area may be adjusted. In the present embodiment, when the application is in the video mode, the mapped audio manipulation area may be used to control the sound source corresponding to the first operation response area in the corresponding acquisition area of the captured video image, thereby realizing the control of the sound collection effect of the sound source corresponding to the first operation response area. Therefore, the sound source in the video images may be based on the user's control of a certain operation response area in the image acquisition area, and the selection of the sound source in the video images may be achieved, to effectively avoid the problem of degraded user experience caused by more noise in the video images.

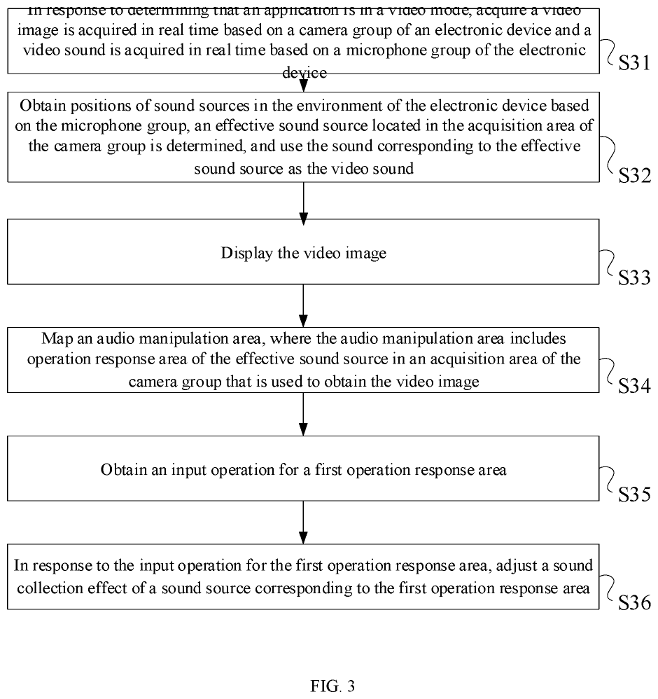

Another embodiment shown in FIG. 3 provides another information processing method. As shown in FIG. 3, the method includes S31 to S36.

At S31, in response to determining that an application is in a video mode, a video image is acquired in real time based on a camera group of an electronic device and a video sound is acquired in real time based on a microphone group of the electronic device.

At S32, positions of multiple sound sources (also referred to as “candidate sound sources”) in the environment where the electronic device is located are obtained based on the microphone group of the electronic device, effective sound sources located in the acquisition area of the camera group are determined from the multiple sound sources, and the sound corresponding to the effective sound sources is used as the video sound.

At S33, the video image is displayed.

At S34, the audio manipulation area is mapped. The audio manipulation area includes the operation response areas of the effective sound sources in the acquisition area of the camera group that obtains the video image.

At S35, an input operation for the first operation response area is obtained.

At S36, in response to the input operation for the first operation response area, the sound collection effect for the sound source corresponding to the first operation response area is adjusted.

The video sound may be obtained in real time through the microphone group. Specifically, the sound in the environment may be analyzed, and the positions of multiple sound sources in the environment may be determined by analyzing the position information contained in the sound.

Based on the positions of the sound sources, it may be determined which sound sources of the multiple sound sources are located in the acquisition area and which sound sources are located outside the acquisition area. The sound sources within the acquisition area may be determined as effective sound sources, and the sound sources outside the acquisition area may be determined as ineffective sound sources.

The video sound obtained by the microphone group in real time may be the sound of the effective sound sources in the acquisition area. After analyzing the positions of the sound sources, the microphone group may determine the effective sound sources in the acquisition area, such that only the sound of the effective sound sources in the acquisition area may be acquired and the sound of the ineffective sound sources may be not collected.

In another embodiment, after determining the effective sound sources within the acquisition area and the ineffective sound sources outside the acquisition area, the ineffective sound sources outside the acquisition area may be suppressed to realize the acquisition of the effective sound sources in the acquisition area by the microphone group. Specifically, the sound collected by the microphone group in the suppression area may be suppressed to suppress the ineffective sound sources outside the acquisition area. The suppression area may be the area outside the acquisition area.

Further, after determining the positions of multiple sound sources in the environment, the electronic device may determine the effective sound sources in the acquisition area and suppress the ineffective sound sources outside the acquisition area. When mapping the audio manipulation area through the display screen of the electronic device, the audio manipulation area may only include the operation response areas corresponding to the effective sound sources in the acquisition area.

The audio manipulation area may prompt the user in which direction of the electronic device there are the effective sound sources, such that the user is able to operate the operation response areas to determine the direction where the sound collection effects of the effective sound sources need to be adjusted based on the user's input operation.

Further, the positions of the effective sound sources may be superimposed and displayed based on the video image, and a position of each effective sound source may correspond to an operation response area.

When the display screen displays the video image, the positions of the effective sound sources may be simultaneously displayed on the display screen, such that the user is able to perform operations on the effective sound sources based on the position of the effective sound sources displayed on the display screen.

When the user performs the input operation on one operation response area, since each effective sound source corresponds to one operation response area, the input operation performed by the user on the operation response area may be actually an adjustment operation of the sound collection effect of the effective sound source corresponding to the operation response area.

When there are multiple effective sound sources in the acquisition area, the sound sources at different positions may be displayed at different positions on the display screen, and there may also be one operation response area corresponding to each effective sound source at the corresponding position. When the user needs to adjust the sound collection effect of an effective sound source in a certain direction in the acquisition area, the user may directly perform the input operation at the position displayed on the display screen corresponding to the direction, to adjust the sound collection effect of the effective sound source in the direction.

When the video image is displayed on the display screen and the positions of the effective sound sources are superimposed and displayed at the same time, the positions of the effective sound sources may be identified by regular area frames. When the area frames are used to identify the positions of the effective sound sources, the area frames may be displayed with a certain degree of transparency to avoid blocking the video image displayed on the display screen. In some other embodiments, the positions of the effective sound sources may be displayed by identification points.

When the positions of the effective sound sources are identified by the area frames, the area frames may be directly used as the operation response areas corresponding to the effective sound sources. When the user wants to adjust the sound collection effects of the effective sound sources, the user may perform the input operation in the area frames. For example, operations of swiping left or right, or swiping up or down, may respectively correspond to: left or down to decrease the volume, right or up to increase the volume.

When the positions of the effective sound sources are identified by the identification points, a sliding operation may be performed directly based on the identification points, for example, sliding up or down, left or right. In another embodiment, each point may be used as a center of a circle, and the circle with a preset length as the radius may be used as the operation response area.

In some other embodiments, the positions of the effective sound sources and the operation response areas of the effective sound sources may be set at different positions of the display screen. The positions of the effective sound sources may be determined based on the actual orientations of the effective sound sources and cannot be adjusted. For the operation response areas of the effective sound sources, for example, the operation response areas of all the effective sound sources can be set in one place. In the acquisition area, the orientations of different effective sound sources may be different, an operation area may be set on the display screen, and the operation area may include the operation response areas of all sound sources in the acquisition area. The operation response areas of the sound sources in different directions may be set in different positions of the operation area, to realize the adjustment of the sound collection effects of the effective sound sources in different positions.

The adjustment of the sound collection effect of one effective sound source may be: increasing gain of the effective sound source at a first position based on the obtained video sound to make the sound of the effective sound source at the first position in the video sound clear.

The adjustment of the sound collection effect of the video sound in the acquisition area obtained by the microphone group may be realized by adjusting the volume of different sound sources or by adjusting the gain of different sound sources.

When the user wants to adjust the sound collection effect of the effective sound source at the first position of the acquisition area, the corresponding operation response area in the audio manipulation area may be determined based on the first position, and the input operation may be performed in the operation response area. The gain of the sound of the effective sound source at the first position may be increased by increasing the gain to make the sound of the effective sound source at the first position clearer. In another embodiment, the gain of the sound of the effective sound source at the first position may be reduced to make the sound of the effective sound source at the first position inconspicuous.

The method may further include: displaying sound parameters of the effective sound source in real time at a position where the position of the effective sound source is superimposed and displayed based on the video image.

The sound parameters may include the volume of the sound, the degree of clarity, or the gain of the sound.

While the video image is displayed on the display screen, the position of the effective sound source may be superimposed and displayed, and the current sound parameters of the effective sound source may be also displayed at the position where the position of the effective sound source is superimposed and displayed, such that the adjustment effect may be directly displayed through the sound parameters and the changes of the displayed parameters may reflect the changes of the sound of the effective sound source when the user adjusts the sound collection effect of the effective sound source.

When the electronic device is in the video mode, no matter whether before the recording starts or during the recording, while the video image is displayed on the display screen, the current sound parameters of the effective sound source may be also displayed at the position where the position of the effective sound source is superimposed and displayed, to intuitively express the sound collection effect of the sound. Further, before the recording starts or during the recording process, when the sound collection effect of the effective sound source is adjusted, the adjustment parameters may be displayed intuitively at the position in the display screen corresponding to the effective sound, such that how much the parameters are adjusted may be directly determined according to the displayed parameters. Further, before the recording starts or during the recording process, the parameters of the effective sound source may be adjusted to realize the adjustment of the sound collection effect of the effective sound source. Therefore, after the recording is completed, the sound in the recorded video may directly be the adjusted sound to avoid the noisy sound in the recorded video, and there may be no need to adjust the sound after the recording is completed.

In the information processing method provided by the present embodiment, when the application is in the video mode, the video image may be obtained in real time based on the camera group of the electronic device and the video sound may be obtained in real time based on the microphone group of the electronic device. The video image may be displayed, and the audio manipulation area may be mapped. The audio manipulation area may include the operation response area of the sound source in the acquisition area of the camera group that obtains the video image. The input operation for the first operation response area may be obtained. In response to the input operation for the first operation response area, the sound collection effect of the sound source corresponding to the first operation response area may be adjusted. In the present embodiment, when the application is in the video mode, the mapped audio manipulation area may be used to control the sound source corresponding to the first operation response area in the corresponding acquisition area of the captured video image, thereby realizing the control of the sound collection effect of the sound source corresponding to the first operation response area. Therefore, the sound source in the video images may be based on the user's control of a certain operation response area in the image acquisition area, and the selection of the sound source in the video images may be achieved, to effectively avoid the problem of degraded user experience caused by more noise in the video images.

The information processing methods provided by the above embodiments may be all implemented based on the following solutions. When the application is in the video mode, the video image may be obtained in real time based on the camera group of the electronic device and the video sound may be obtained in real time based on the microphone group of the electronic device. The video image may be displayed, and the audio manipulation area may be mapped. The audio manipulation area may include the operation response area of the sound source in the acquisition area of the camera group that obtains the video image. The input operation for the first operation response area may be obtained. In response to the input operation for the first operation response area, the sound collection effect of the sound source corresponding to the first operation response area may be adjusted. That is, the video sound in the above solutions may all correspond to the sound obtained by the microphone group of the sound source in the acquisition area corresponding to the camera group that obtains the video image, that is, the video sound may be the sound of the sound source in the acquisition area.

For example, the corresponding application scenario may be that: the image is collected by the rear camera of the mobile phone, the video sound obtained by the microphone group is the sound of the sound source in the acquisition area of the rear camera, and the sound of the sound source in an area outside the rear camera is not acquired directly, or is not acquired by means of suppression.

For another example, the corresponding application scenario may be that: the video image is obtained in real time through the camera group, and the video sound is obtained in real time based on the microphone group. The video sound is the sound of the sound source outside the acquisition area of the camera group that obtains the video image. The sound of the sound source in the acquisition area is not acquired by means of suppression. That is, the acquisition area is determined as the suppression area, and the sound outside the suppression area, that is, the sound outside the acquisition area, is obtained.

For example, when a host is performing live broadcasting, the host holds the electronic device and records the image through the rear camera of the electronic device. At this time, the host is on the display side of the electronic device, and the host is outside the acquisition area of the rear camera and outside the acquisition area of the rear camera. Therefore, the acquisition area of the rear camera is determined as the suppression area, the sound in the acquisition area of the rear camera is suppressed, and the sound outside the acquisition area of the rear camera is acquired. Further, the sound source outside the acquisition area may be further selected through the mapped audio manipulation area, to make the sound collection effect better.

The method of this embodiment may also realize the adjustment of the video sound obtained by the microphone group and improve the sound collection effect of the sound source. In the present embodiment, the sound collection effect of the sound source outside the acquisition area of the camera group that is used to obtain the video image may be adjusted, to realize the selection of the sound source in the video image and effectively avoid the problem that the user experience is degraded due to more noise in the video image.

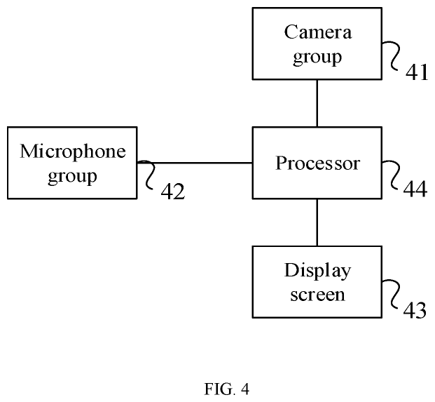

The present disclosure provides an electronic device. As shown in FIG. 4, in one embodiment, the electronic device includes a camera group 41, a microphone group 42, a display screen 43, and a processor 44.

The camera group 41 may be configured to obtain the video image.

The microphone group 42 may be configured to obtain the video sound.

The display screen 43 may be configured to display the video image.

The processor 44 may be configured to: obtain the video image in real time based on the camera group when the application is in the video mode; obtain the video sound in real time based on the microphone group; display the video image through the display screen; map the audio manipulation area including the operation response area of the sound source in the acquisition area of the camera group used to obtain the video image; and obtain the input operation for the first operation response area; in response to the input operation for the first operation response area, adjust the sound collection effect of the sound source corresponding to the first operation response area.

Further, when the application is in the video mode, the processor may be configured to obtain the video image in real time based on the camera group and obtain the video sound in real time based on the microphone group, by:

determining the suppression region based on the acquisition area of the camera called by the application in the video mode, and suppressing the sound collected by the microphone group in the suppression region based on the suppression region to obtain the video sound.

The processor may be further configured to: obtain the positions of multiple sound sources in the environment where the electronic device is located, and determine the effective sound source located in the acquisition area of the camera group.

Further, when mapping the audio manipulation area, the processor may be configured to:

superimpose and display the position of the effective sound source based on the video image, where the position of each effective sound source corresponds to an operation response area.

Further, in response to the input operation for the first operation response area, the processor may be configured to:

increase the gain of the effective sound source at the first position based on the obtained video sound, such that the sound of the effective sound source at the first position in the video sound is clear.

Further, the processor may be further configured to: display the sound parameters of the effective sound source in real time at the position in the display screen where the position of the effective sound source is superimposed and displayed based on the video image.

The electronic device disclosed in this embodiment may be implemented based on the information processing methods disclosed in the foregoing embodiments, and details are not described herein again.

In the electronic device provided by the present embodiment, when the application is in the video mode, the video image may be obtained in real time based on the camera group of the electronic device and the video sound may be obtained in real time based on the microphone group of the electronic device. The video image may be displayed, and the audio manipulation area may be mapped. The audio manipulation area may include the operation response area of the sound source in the acquisition area of the camera group that obtains the video image. The input operation for the first operation response area may be obtained. In response to the input operation for the first operation response area, the sound collection effect of the sound source corresponding to the first operation response area may be adjusted. In the present embodiment, when the application is in the video mode, the mapped audio manipulation area may be used to control the sound source corresponding to the first operation response area in the corresponding acquisition area of the captured video image, thereby realizing the control of the sound collection effect of the sound source corresponding to the first operation response area. Therefore, the sound source in the video images may be based on the user's control of a certain operation response area in the image acquisition area, and the selection of the sound source in the video images may be achieved, to effectively avoid the problem of degraded user experience caused by more noise in the video images.

The various embodiments in this specification are described in a progressive manner, and each embodiment focuses on the differences from other embodiments. The same and similar parts between the various embodiments may be referred to each other. As for the device disclosed in the embodiment, since it corresponds to the method disclosed in the embodiment, the description is relatively simple, and the relevant part can be referred to the description of the method.

Professionals may further realize that the units and algorithm steps of each example described in conjunction with the embodiments disclosed herein can be implemented in electronic hardware, computer software, or a combination of the two. To clearly illustrate the interchangeability of hardware and software, the above description has generally described the components and steps of each example in terms of functionality. Whether these functions are performed in hardware or software depends on the specific application and design constraints of the technical solution. Those skilled in the art may implement the described functionality using different methods for each particular application, but such implementations should not be considered beyond the scope of the present disclosure.

The steps of a method or algorithm described in conjunction with the embodiments disclosed herein may be directly implemented in hardware, a software module executed by a processor, or a combination of the two. Software modules can be placed in a random access memory (RAM), an internal memory, a read only memory (ROM), an electrically programmable ROM, an electrically erasable programmable ROM, registers, a hard disk, a removable disk, a CD-ROM, or any other storage medium.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. An information processing method comprising:
in response to determining that an application is in a video mode, acquiring a video image in real time through a camera group of an electronic device and acquiring a video sound in real time through a microphone group of the electronic device;
displaying the video image;
mapping an audio manipulation area, the audio manipulation area including an operation response area of a sound source in an acquisition area of the camera group;
obtaining an input operation for the operation response area; and
in response to the input operation, adjusting a sound collection effect of the sound source corresponding to the operation response area.

2. The method according to claim 1, wherein acquiring the video sound includes:
determining a suppression area based on an acquisition area of a camera called by the application in the video mode; and
based on the suppression area, suppressing sound in the suppression area collected by the microphone group to obtain the video sound.

3. The method according to claim 1, further comprising:
obtaining positions of a plurality of candidate sound sources in an environment where the electronic device is located; and
determining the sound source in the acquisition area of the camera group from the plurality of candidate sound sources.

4. The method according to claim 3, wherein mapping the audio manipulation area includes:
superimposing and displaying a position of the sound source in the acquisition area based on the video image, the position of the sound source in the acquisition area corresponding to the operation response area.

5. The method according to claim 4, wherein adjusting the sound collection effect of the sound source corresponding to the operation response area includes:
increasing a gain of the sound source based on the video sound.

6. The method according to claim 4, further comprising:
displaying a sound parameter of the sound source in real time at a position where the position of the sound source is superimposed and displayed based on the video image.

7. An electronic device comprising:
a camera group;
a microphone group;
a display screen; and
a processor configured to:
in response to determining that an application is in a video mode, control the camera group to acquire a video image in real time and control the microphone group to acquire a video sound in real time;
control the display screen to display the video image;
map an audio manipulation area, the audio manipulation area including an operation response area of a sound source in an acquisition area of the camera group;
obtain an input operation for the operation response area; and
in response to the input operation, adjust a sound collection effect of the sound source corresponding to the operation response area.

8. The electronic device according to claim 7, wherein the processor is further configured to:
determine a suppression area based on an acquisition area of a camera called by the application in the video mode; and
based on the suppression area, suppress sound in the suppression area collected by the microphone group to obtain the video sound.

9. The electronic device according to claim 7, wherein the processor is further configured to:
obtain positions of a plurality of candidate sound sources in an environment where the electronic device is located; and
determine the sound source in the acquisition area of the camera group from the plurality of candidate sound sources.

10. The electronic device according to claim 9, wherein the processor is further configured to:
control the display screen to superimpose and display a position of the sound source in the acquisition area based on the video image, the position of the sound source in the acquisition area corresponding to the operation response area.

11. The electronic device according to claim 10, wherein the processor is further configured to:
increase a gain of the sound source based on the video sound.

12. The electronic device according to claim 10, wherein the processor is further configured to:
control the display screen to display a sound parameter of the sound source in real time at a position where the position of the sound source is superimposed and displayed based on the video image.
